(19) United States
(12) Patent Application Publication
(10) Pub. No.: US 2026/0231122 A1
(43) Pub. Date: Aug. 6, 2026

(54) SSB STRUCTURES FOR FAST UE BEAM TRACKING

(71) Applicant: Google LLC, Mountain View, CA (US)

(72) Inventors: Yushu ZHANG, Beijing (CN); Jong-Kae FWU, Sunnyvale, CA (US)

(21) Appl. No.: 19/149,333

(22) PCT Filed: Feb. 17, 2023
(86) PCT No.: PCT/CN2023/076877

§ 371 Date: Jul. 18, 2025

(51) Int. Cl. H04W 72/0446

(52) U.S. Cl. CPC H04W 72/0446

(57) ABSTRACT

This disclosure provides systems, devices, apparatus, and methods, including computer programs encoded on storage media, for SSB structures for fast UE beam tracking. A UE (102) receives (306), from a network entity (104), a first time-domain portion of an SSB associated with a first beam and a second time-domain portion of the SSB associated with a second beam. The first time-domain portion and the second time-domain portion occur within a same symbol. The UE (102) communicates (310) with the network entity (104) based on an intra-symbol beam sweeping procedure that includes a measurement (308) of the first time-domain portion of the SSB and the second time-domain portion of the SSB.

### TECHNICAL FIELD

The present disclosure relates generally to wireless communication, and more particularly, to synchronization signal block (SSB) transmissions for user equipment (UE) beam tracking.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a network entity periodically transmits synchronization signal blocks (SSBs) to the UE for the UE to perform beam quality measurements. However, increased latency may be caused by the UE having to perform multiple SSB measurement instances of the SSBs over a period of time. Additionally, activating multiple UE panels to simultaneously receive multiple SSBs from the network entity may result in increased power consumption by the UE.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, may use different network beams to transmit synchronization signal blocks (SSBs) to a user equipment (UE). A single SSB includes a primary synchronization signal (PSS), a secondary synchronization signal (SSS), and a physical broadcast channel (PBCH) signal. In some examples, demodulation reference signal (DMRS) for PBCH may also be part of the SSB. The network entity may transmit the SSBs to the UE periodically for the UE to perform a beam quality measurement.

A UE that is capable of analog beamforming may receive the SSBs from the network entity through a codebook-based UE beam search or a channel analysis-based UE beam search. For the codebook-based UE beam search, the UE maintains a plurality of UE beams for receiving the SSBs and selects a UE beam with a largest measured beam quality. Although simultaneous panel activation for receiving the SSBs may reduce a beam tracking latency, the UE may experience increased power consumption as a result of having multiple panels activated simultaneously. For the channel analysis-based UE beam search, the UE may receive an SSB on different symbols using different UE antennas and reconstruct the channel based on multiple measurement instances. However, the multiple measurement instances for the UE to identify the strongest beam may result in increased latency.

Aspects of the present disclosure address the above-noted and other deficiencies by implementing an SSB structure for intra-symbol beam tracking techniques that provide faster UE beam tracking than traditional channel analysis-based UE beam searches and with less power consumption costs than traditional codebook-based UE beam searches. The UE performs the intra-symbol beam sweeping procedure by activating different UE beams to receive repetitions of the SSB within a same symbol. In some implementations, the UE receives portions of the SSB with an interleaved frequency-domain multiplexing access (IFDMA) resource mapping, a wider subcarrier spacing than the PSS of the SSB, and/or a discrete Fourier transform (DFT) pre-processing procedure applied to the SSB. The intra-symbol beam tracking may improve an overall beam management process, which may thereby reduce end-to-end delays.

According to some aspects, the UE receives, from the network entity, a first time-domain portion of the SSB associated with a first beam and a second time-domain portion of the SSB associated with a second beam. The first time-domain portion and the second time-domain portion occurs within a same symbol. The UE communicates with the network entity based on an intra-symbol beam sweeping procedure that includes a measurement of the first time-domain portion of the SSB and the second time-domain portion of the SSB.

According to some aspects, the network entity transmits, within a same symbol to the UE, the first time-domain portion of the SSB and the second time-domain portion of the SSB, as described above. The first time-domain portion is associated with a first UE beam and the second time-domain portion is associated with a second UE beam. The network entity receives, from the UE, at least one of an access request or a beam report based on the intra-symbol beam sweeping procedure for the first UE beam and the second UE beam.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2B illustrate diagrams of example synchronization signal block (SSB) transmissions.

FIG. 3 illustrates a signaling diagram for intra-symbol beam tracking.

FIG. 4 illustrates diagrams of SSB structures with an interleaved frequency-domain multiplexing access (IFDMA) resource mapping.

FIG. 5 illustrates diagrams of SSB resources with a wider subcarrier spacing than a primary synchronization signal (PSS) of the SSB.

FIG. 6 illustrates diagrams of SSB structures associated with a discrete Fourier transform (DFT) pre-processing procedure.

FIG. 7 is a flowchart of a method of wireless communication at a UE.

FIG. 8 is a flowchart of a method of wireless communication at a network entity.

FIG. 9 is a diagram illustrating a hardware implementation for an example UE apparatus.

FIG. 10 is a diagram illustrating a hardware implementation for one or more example network entities.

### DETAILED DESCRIPTION

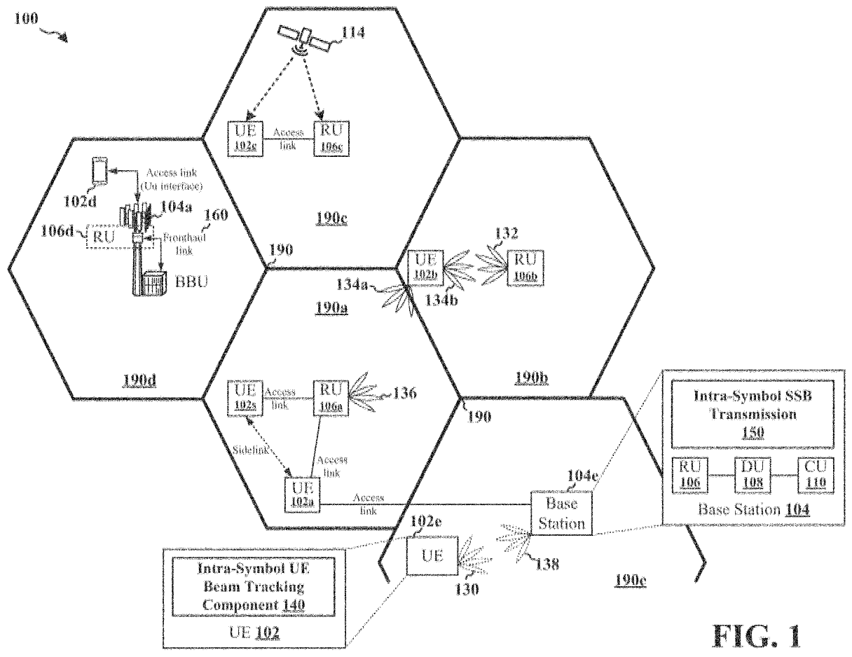

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the RUs 106a-106d may communicate with respective UEs 102a-102d and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104 of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FRI and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station/RU 104a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, the UE 102 may include an intra-symbol UE beam tracking component 140 configured to receive, from a network entity, a first time-domain portion of a synchronization signal block (SSB) associated with a first beam and a second time-domain portion of the SSB associated with a second beam, the first time-domain portion and the second time-domain portion occurring within a same symbol; and communicate with the network entity based on an intra-symbol beam sweeping procedure that includes a measurement of the first time-domain portion of the SSB and the second time-domain portion of the SSB.

In certain aspects, the base station 104 or a network entity of the base station 104 may include an intra-symbol SSB transmission component 150 configured to transmit, within a same symbol to a UE, a first time-domain portion of an SSB and a second time-domain portion of the SSB, the first time-domain portion associated with a first UE beam and the second time-domain portion associated with a second UE beam; and receive, from the UE, at least one of an access request or a beam report based on an intra-symbol beam sweeping procedure for the first UE beam and the second UE beam.

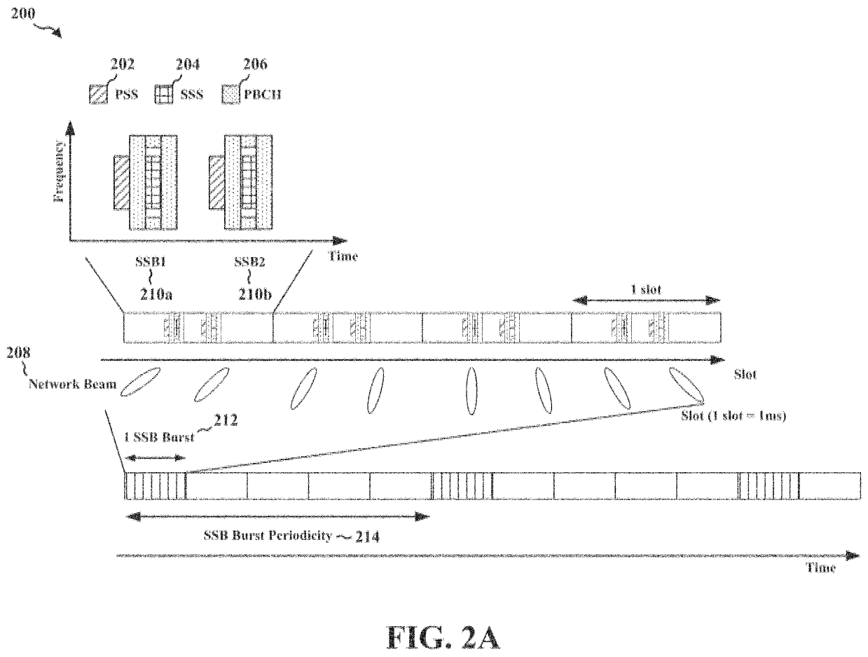

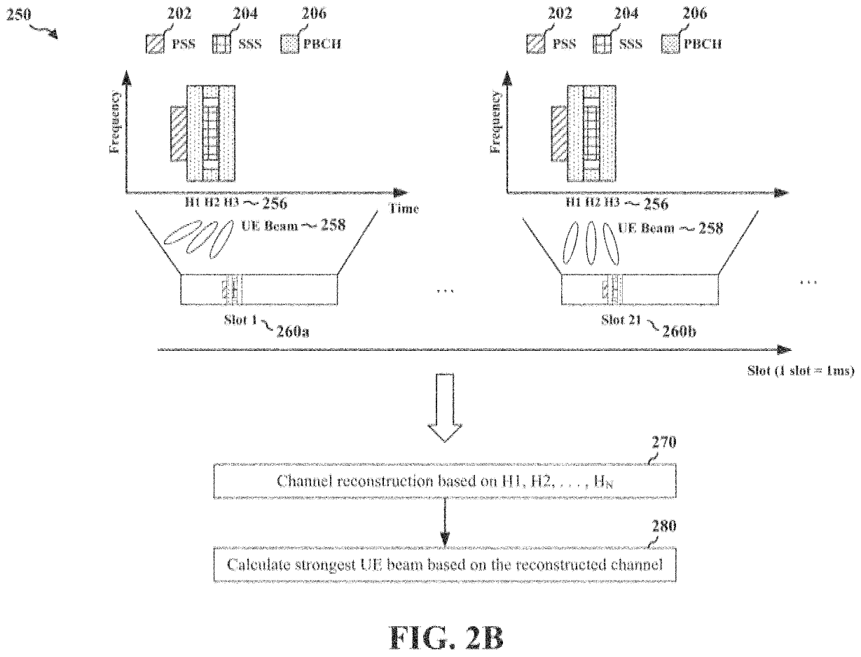

Accordingly, FIG. 1 describes a wireless communication system that may be implemented in connection with aspects of one or more other figures described herein, such as aspects illustrated in FIGS. 2-6. Further, although the following description may be focused on 5G NR, the concepts described herein may be applicable to other similar areas, such as 5G-Advanced and future versions, LTE, LTE-advanced (LTE-A), and other wireless technologies, such as 6G.

FIGS. 2A-2B illustrate diagrams 200-250 of example SSB transmissions. A network entity may use different network beams 208 to transmit SSBs 210 to a UE. A single SSB 210 includes a primary synchronization signal (PSS) 202, a secondary synchronization signal (SSS) 204, and a physical broadcast channel (PBCH) 206, such as illustrated via the time-frequency resources of the diagrams 200-250 where the vertical axis corresponds to the frequency domain and the horizontal axis corresponds to the time domain.

Each 1 millisecond (ms) slot may include a first SSB 210a and a second SSB 210b. The network entity transmits the SSBs 210 periodically via the network beams 208. In examples, the periodicity of the SSB transmissions occurs over a duration of 4 slots, which may comprise 1 SSB burst 212. A duration of the SSB burst 212 relative to an SSB burst periodicity 214 may correspond to a 1:5 ratio in time-domain. That is, for every 4 consecutive slots that comprise the SSB burst 212, there may be 16 subsequent slots (of 20 total slots in the SSB burst periodicity 214) that do not include an SSB burst 212. Thus, the overall periodicity for the SSB burst 212 is 20 ms.

The UE may perform an analog beamforming operation to receive the SSB(s) 210 from the network entity, where a downlink signal reception of a network beam 208 by the UE may be based on a codebook-based UE beam search or a channel analysis-based UE beam search. For the codebook-based UE beam search, the UE maintains a plurality of UE beams for receiving the SSB 210. For example, the UE receives the SSB 210 with different UE beams and selects a UE beam from the plurality of UE beams with a largest measured beam quality (e.g., a largest layer 1-reference signal received power (L1-RSRP)). The UE may perform a symbol-level beam sweeping/scan for the SSBs 210 to identify the largest quality UE beam. However, in some cases, the UE may be limited to 3 or 4 UE beams measurement instances per SSB occasion. For example, with only 3 different PSS sequences being predefined for the UE, the PSS symbol may not be applicable to the UE beam sweeping procedure. Hence, the UE would have to measure one or more remaining beams during a next SSB occasion.

In the diagram 250 of FIG. 2B, where 1 slot is equal to 1 ms, a periodicity of the SSB occasion from slot 1 260a to slot 21 260b is 20 ms. For a codebook-based beam search, if the UE has 8 beams and 3 panels and activates one panel at a time, the UE can measure 3 UE beams 258 per SSB occasion for the beam search procedure. Since the UE has to measure the SSB 8 times for the 8 different UE beams 258, a latency of the beam search procedure for identifying the strongest UE beam 258 is 160 ms (e.g., 8 SSB measurement instances x 20 ms periodicity). In another example, where the UE still has 8 beams to measure and 3 panels, but the UE is able to activate all 3 panels simultaneously, the UE can measure 3 UE beams 258 per SSB occasion for the beam search procedure. For example, the UE has 3 measurement occasions based on SSB ceil(8/3)=3, such that the latency of the beam search procedure for identifying the strongest UE beam 258 is reduced to 60 ms (e.g., 3 SSB measurement occasions×20 ms periodicity). Although a beam tracking latency for simultaneous panel activation is reduced in comparison to individual panel activations, the UE may experience increased power consumption as a result of having to simultaneously activate multiple panels.

For a channel analysis-based beam search, the UE may receive the SSB 210 on different symbols based on different UE antennas and reconstruct the channel 256 using the multiple measurement instances. For example, the UE calculates an eigenvector for the reconstructed channel and selects a first row of the eigenvector as corresponding to the strongest UE beam. Due to the UE using different antennas to receive the SSB 210 at different measurement occasions, the channel H for each measurement instance from a UE antenna j may be indicated as Hi, such that the UE can reconstruct 270 the channel 256 based on:

$$H = [ {H}_{1} , {H}_{2} , … , {H}_{N} ]$$

where N corresponds to a number of antenna elements for a UE panel. The UE may then calculate the eigenvector of the reconstructed channel based on:

$${USV}^{H} = {H}^{H} H$$

where U is the left singular matrix, S is a diagonal matrix with singular values, and V is the right singular matrix. The UE selects the first row of matrix V as a calculation 280 of the strongest UE beam based on the reconstructed channel. A similar approach may be applicable to devices with multiple receiver chains.

An increase in latency for the UE to identify the strongest beam may result from the channel analysis-based beam search being based on multiple SSB measurement occasions. For example, if the UE has 3 panels with 4 antennas per panel and 1 port, the UE may scan for/receive the SSB 4 times using the 12 antennas in rotation. If the SSB periodicity is 20 ms, an overall delay for the channel analysis-based beam search is 80 ms (e.g., 4 SSB measurement occasions×20 ms periodicity). However, a phase noise may cause a phase error in the estimated/reconstructed 270 channel if a measurement gap between the measurement occasions becomes too large (e.g., greater than 1 or 2 slots).

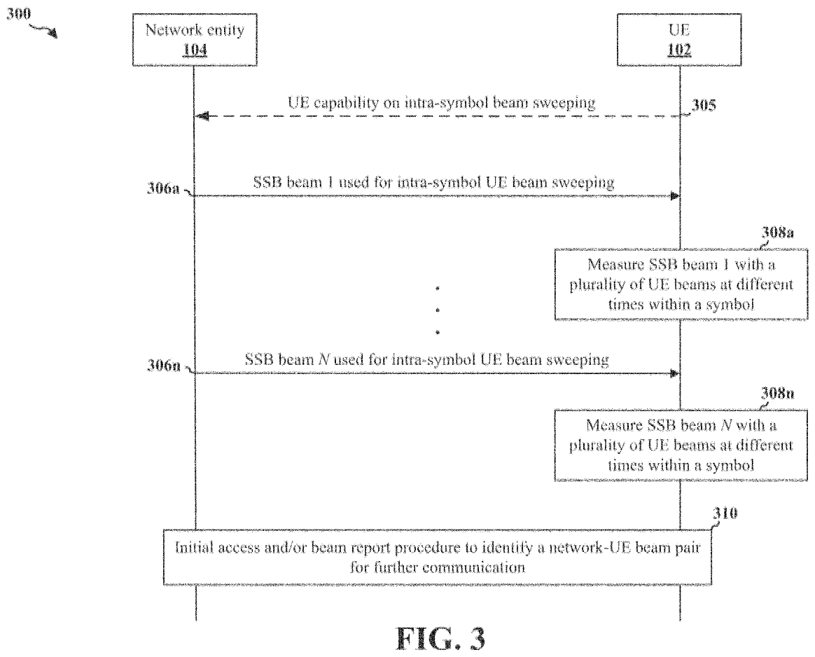

Accordingly, the UE may implement techniques with decreased latency for UE beam tracking based on SSB transmissions. The decreased latency may be provided via an SSB framework for intra-symbol beam tracking, SSB repetition for UE beam tracking, and/or joint SSB and channel state information-reference signal (CSI-RS)-based UE beam tracking. The reduced UE beam tracking latency may improve an overall beam management process, which may thereby reduce end-to-end delays. FIGS. 2A-2B show SSB transmission schemes. FIG. 3 describes an intra-symbol beam sweeping procedure for the SSBs.

FIG. 3 illustrates a signaling diagram 300 for intra-symbol beam tracking. The network entity 104 transmits 306a-306n SSBs to a UE 102 that the UE 102 uses for intra-symbol beam sweeping (i.e., beam sweeping within a same symbol). SSB transmissions 306a-306n from the network entity 104 to the UE 102 may be periodic, where at least one of the SSB transmissions 306a-306n corresponds to an intra-symbol repetition. For example, the network entity 104 transmits 306a SSB 1 to the UE 102, as well as a repetition of SSB 1, within a same symbol. The network entity 104 may similarly transmit 306n SSB N to the UE 102 with a repetition in the same symbol.

The UE 102 activates different UE beams to receive 306a-306n the SSBs from the network entity 104. Intra-symbol repetitions provide the UE 102 with a technique for fast beam tracking. The UE 102 measures 308a SSB 1 with a plurality of UE beams at different times within the same symbol. The UE 102 may similarly measure 308n SSB N with a plurality of UE beams at different times within another same symbol. The UE 102 and the network entity 104 may perform 310 an initial access and/or beam report procedure to identify a network-UE beam pair for further communication.

For channel analysis-based UE beam tracking, the UE 102 receives different intra-symbol repetitions with different UE antenna(s). The different UE antennas may be associated with different UE beams, and different UE antenna panels may be associated with different UE antennas and/or different UE beams. The UE 102 may perform 310 the initial access procedure (e.g., random access procedure), if the UE 102 is in an idle mode. The UE 102 performs 310 beam reporting (e.g., L1-RSRP report), if the UE is in a connected mode. The network entity 104 can maintain a phase continuity for signals in each SSB symbol for channel analysis-based UE beam search procedures.

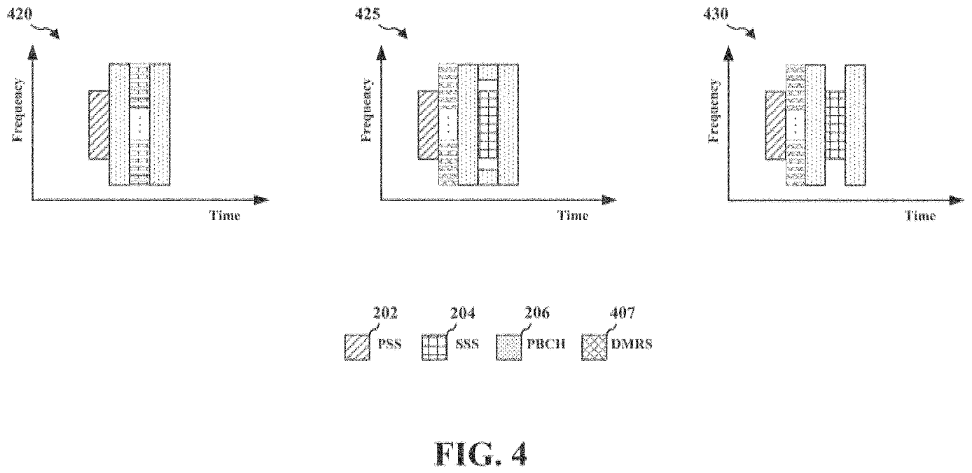

In some implementations, the network entity 104 transmits a configuration to the UE 102 through radio resource control (RRC) signaling for the intra-symbol beam sweeping. The RRC signaling may indicate an RRCReconfiguration message from the network entity 104 to the UE 102 or a system information block (SIB), where the SIB may be a traditional type of SIB (e.g., SIB1) or a different SIB (e.g., SIB J, where J corresponds to an integer greater than 21) transmitted by the network entity 104. FIG. 3 describes intra-symbol UE beam sweeping of SSBs received from a network entity 104. FIGS. 4-6 illustrate different SSB structures for the intra-symbol UE beam sweeping.

FIG. 4 illustrates diagrams 420-430 of SSB structures with an interleaved frequency-domain multiplexing access (IFDMA) resource mapping. For example, the diagram 420 illustrates example resources for IFDMA-based SSS 204 with a repetition factor (RPF) of 2. That is, the network entity transmits the SSS 204 (e.g., every other/every second resource element (RE) or subcarrier), such that the SSS 204 is repeated at interleaved REs along the bandwidth for the SSS symbol. The RPF of the IFDMA-based SSS 204 may be predefined at values such as RPF=1, 2, or 4. The RPF may also be predefined per band or per frequency range (FR) (e.g., FR1, FR2, certain sub-THz or THz bands, such as 100 Ghz to 300 GHz, etc.).

The network entity can multiplex the PSS 202, the SSS 204, and the PBCH 206 via time-domain multiplexing (TDM) techniques and transmit the SSS 204 at one or more symbols. The UE may receive the repetitions based on the RPF for the SSS symbol to scan for multiple UE beams during the SSS symbol. The network entity may apply power boosting (e.g., 10 log₁₀ (RPF) dB) at non-zero-power resource elements (e.g., the interleaved REs of the SSS symbol that do not include the SSS 204). Thus, the energy per resource element (EPRE) between the SSS 204 and the PSS 202, DMRS 407 for the PBCH 206, or the PBCH 206 may be determined based on the RPF for the SSS 204. In examples, the EPRE ratio between the SSS 204 and the PSS 202, DMRS 407 for the PBCH 206, or the PBCH 206 is 10 log₁₀ (RPF) dB.

The network entity selects the RPF from candidate RPF sets. The candidate RPF sets may be predefined (e.g., as {1, 2, 4}). The UE may perform blind detection during an initial access procedure based on the predefined candidate RPF sets. The network entity may also configure the RPF through RRC signaling (e.g., the RRCReconfiguration, a master information block (MIB), or a SIB) after the UE is in a connected mode with the network entity.

The diagrams 425-430 illustrate example resources for IFDMA-based demodulation reference signal (DMRS) 407 for PBCH 206 with RPF=2. In the diagram 425, the PBCH 206 and the SSS 204 are multiplexed in the same symbol. In the diagram 430, the PBCH 206 and the SSS 204 are multiplexed in different symbols.

The network entity transmits the DMRS 407 for the PBCH 206 on at least one symbol using IFDMA techniques. The network entity may transmit the DMRS 407 at REs of a bandwidth based on the RPF. The network entity may transmit one or more DMRSs 407 for the PBCH 206 on one or more symbols for an SSB via IFDMA in one or more slots. The network entity may also transmit the DMRS 407 for the PBCH 206 based on a lower peak-to-average power ratio (PAPR) sequence or a quadrature phase shift keying (QPSK) sequence. The network entity may transmit the PBCH 206 based on a discrete Fourier transform (DFT)-spread-orthogonal frequency division multiplexing (OFDM) (DFT-s-OFDM) waveform or a cyclic prefix (CP)-OFDM waveform. The PBCH 206 may correspond to π/2 binary phase shift keying (BPSK) or the QPSK. The RPF for the DMRS 407 may be predefined or configured by the network entity through RRC signaling.

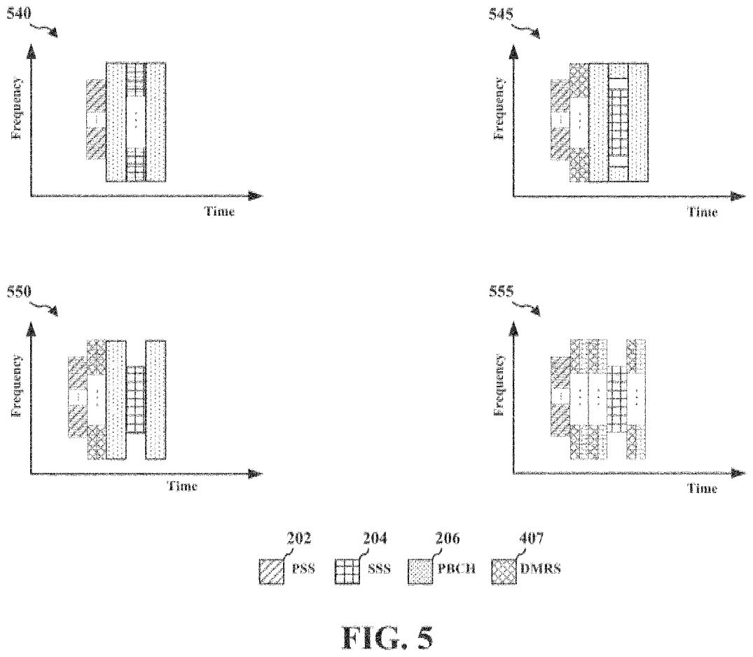

FIG. 5 illustrates diagrams 540-555 of SSB resources with a wider subcarrier spacing (SCS) than a PSS 202 of the SSB. For example, the diagram 540 illustrates resources associated with a wider subcarrier spacing of N=1 for the SSS 204. That is, the wider subcarrier spacing for the SSS 204 is wider than the PSS 202. For instance, the network entity may transmit the SSS 204 based on a subcarrier spacing that is 2^{N} times larger than the subcarrier spacing of the PSS 202, where N corresponds to a scaling factor for the subcarrier spacing. The scaling factor N may be predefined (e.g., as 0, 1, 2). The wider subcarrier spacing may provide N sub-symbols for the SSS 204. In an example for the N sub-symbols of the SSS 204, where N=1, the subcarrier spacing for the SSS 204 is 2 times larger than the subcarrier spacing for the PSS 202. Hence, the SSS 204 is transmitted within a first sub-symbol and a second sub-symbol (e.g., where 2 symbols for a 30 kHz SCS=1 symbol for 15 kHz SCS). The UE may apply different UE beams at the first and second sub-symbols. The network entity can transmit the SSS 204 in one or more symbols. The UE may apply different UE beams at different sub-symbols for fast UE beam tracking. The subcarrier spacing scaling factor N for the wider subcarrier spacing-based SSS 204 may be predefined per band or per FR (e.g., FR1, FR2, certain sub-THz or THz bands, such as 100 Ghz to 300 GHz, etc.).

The network entity selects the subcarrier spacing scaling factor from candidate subcarrier spacing scaling factor sets. The candidate subcarrier spacing scaling factor sets may be predefined (e.g., as {1, 2, 4}). The UE may perform blind detection during the initial access procedure based on the predefined candidate subcarrier spacing scaling factor sets. The network entity may also configure the subcarrier spacing scaling factor through RRC signaling (e.g., the RRCReconfiguration, MIB, or SIB) after the UE is in a connected mode with the network entity.

The diagrams 545-555 illustrate example resources for DMRS 407 with wider subcarrier spacing (e.g., N=1), which may be used for decoding the PBCH 206. In the diagram 545, the PBCH 206 and the SSS 204 are multiplexed in the same symbol with the same subcarrier spacing as the PSS 202. In the diagram 550, the PBCH 206 and the SSS 204 are multiplexed in different symbols with the same subcarrier spacing as the PSS 202. In the diagram 555, the PBCH 206 and the SSS 204 are multiplexed in different symbols and the PBCH 206 is transmitted with the same subcarrier spacing as the DMRS 407.

The network entity can multiplex the DMRS 407 and other signals (e.g., the PSS 202, the SSS 204, and/or the PBCH 206) via TDM. The network entity may transmit the DMRS 407 for the PBCH 206 with a wider subcarrier spacing than the PSS 202. The network entity may transmit the DMRS 407 based on a subcarrier spacing that is 2^{N} times larger than the subcarrier spacing of the PSS 202, where N corresponds to the subcarrier spacing scaling factor. The network entity may transmit one or more DMRSs 407 for the PBCH 206 on one or more symbols for an SSB with the wider subcarrier spacing in one or more slots. The network entity may also transmit the DMRS 407 for the PBCH 206 based on a lower PAPR sequence or a QPSK sequence. The network entity may transmit the PBCH 206 using a DFT-s-OFDM waveform or a CP-OFDM waveform. The PBCH 206 may correspond to π/2 BPSK or the QPSK. The PBCH 206 may have a same subcarrier spacing as the PSS 202 or the DMRS 407. The subcarrier spacing scaling factor for the DMRS 407 may be predefined or configured by the network entity.

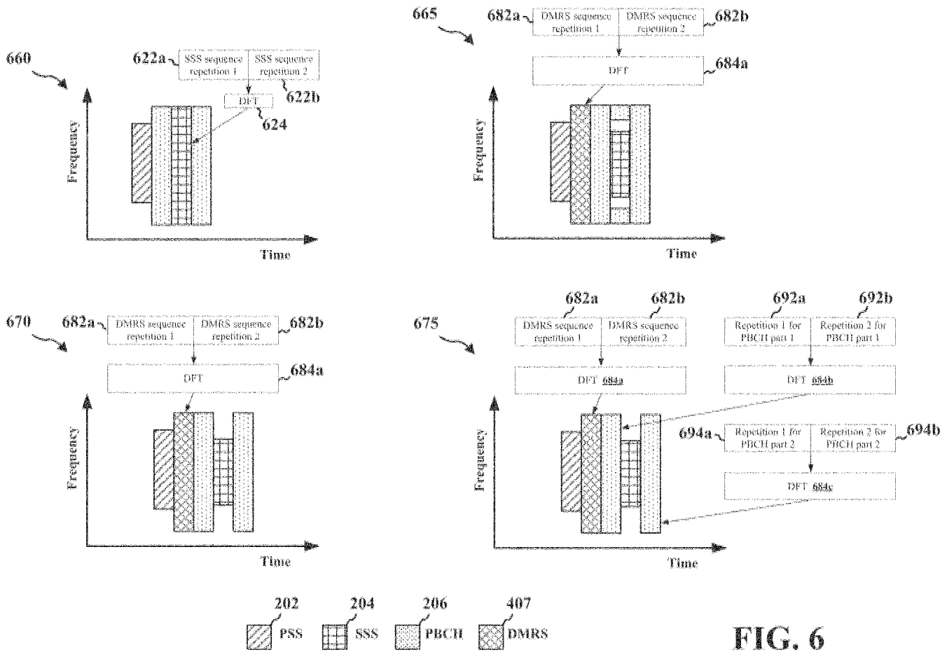

FIG. 6 illustrates diagrams 660-675 of SSB structures associated with a DFT pre-processing procedure. For example, the diagram 660 illustrates example resources for DFT-based SSS with M=2, where M corresponds to a number of repetitions 622 of an SSS sequence. The network entity may transmit the SSS 204 using pre-processing techniques based on DFT 624, where the network entity may apply the DFT 624 to M repetitions 622 of the SSS sequence. In examples, the M repetitions 622 include a first SSS sequence repetition 622a and a second SSS sequence repetition 622b. After applying the DFT 624 to the M repetitions 622, the network entity transmits an output associated with the DFT 624 on resource elements for the SSS 204.

The number M of SSS sequence repetitions 622 per DFT 624 for the SSS 204 may be predefined (e.g., as 1, 2, or 4). DFT techniques may provide M time-domain repetitions 622 within a symbol for the SSS 204. The UE may apply different UE beams at different repetitions for fast UE beam tracking. The number M of SSS sequence repetitions 622 per DFT 624 for the SSS 204 may be predefined per band or per FR (e.g., FR1, FR2, certain sub-THz or THz bands, such as 100 Ghz to 300 GHz, etc.).

The network entity selects the number M of SSS sequence repetitions 622 per DFT 624 for the SSS 204 from a candidate RPF set. The candidate RPF set may be predefined (e.g., as {1, 2, 4}). The UE may perform blind detection during the initial access procedure based on the predefined candidate RPF set. The network entity may also configure the number M of SSS sequence repetitions 622 per DFT 624 for the SSS 204 through RRC signaling (e.g., the RRCReconfiguration, MIB, or SIB) after the UE is in a connected mode with the network entity.

The diagrams 665-675 illustrate example resources for DFT-based DMRS 407 for PBCH 206 with M=2. In the diagram 665, the PBCH 206 and the SSS 204 are multiplexed in the same symbol. In the diagram 670, the PBCH 206 and the SSS 204 are multiplexed in different symbols. In the diagram 675, the PBCH 206 and the SSS 204 are multiplexed in different symbols with the DFTs 684b-684c being mapped to repetitions of the PBCH 206.

The network entity may transmit the DMRS 407 using DFT pre-processing techniques. For example, a first DMRS sequence repetition 682a and a second DMRS sequence repetition 682b are input to the DFT 684a to transmit an output on resource elements for the PBCH 206, as illustrated in the diagram 665, or on resource elements of the DMRS 407, as illustrated in the diagrams 670-675. The network entity may perform DFT 684 for M repetitions of the SSS sequence and map the output of the DFT 684 to the resource elements of the SSS 204. The network entity may transmit the DMRS 407 on one or more symbols for an SSB with DFT-based pre-processing in one or more slots. The number of repetitions M per DFT 684a for the DMRS 407 may be predefined or configured by the network entity. The network entity multiplexes the DMRS 407 and other signals (e.g., PSS 202, SSS 204, and PBCH 206) via TDM for transmission of the DMRS 407 based on IFDMA resource mapping, a wider subcarrier spacing, and/or DFT-based pre-processing.

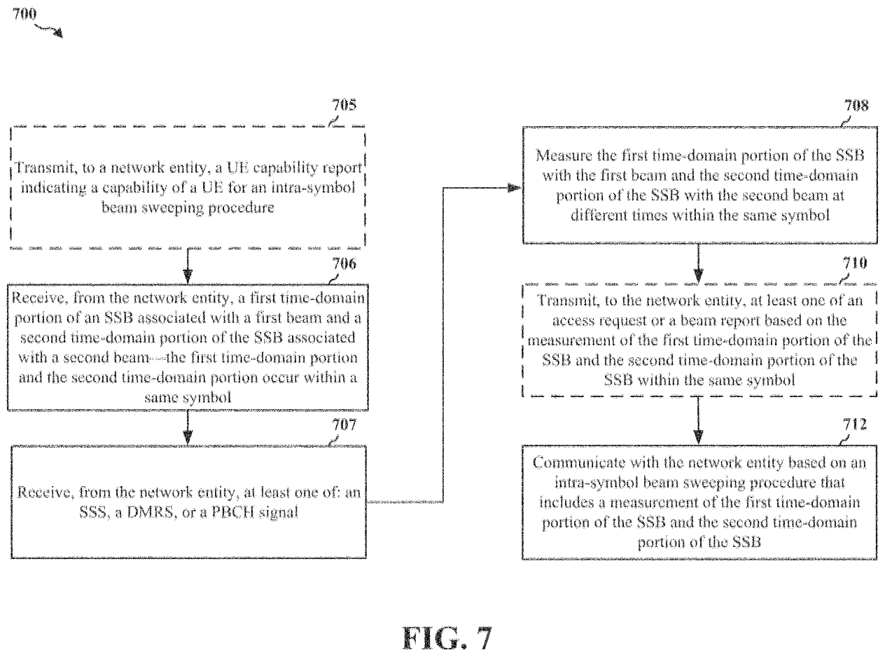

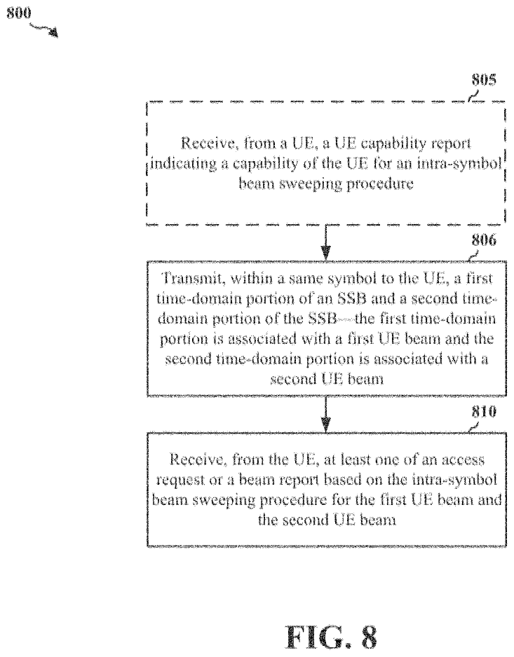

In some implementations, the network entity transmits the PBCH 206 using a DFT-s-OFDM waveform or a CP-OFDM waveform. In other implementations, the network entity transmits the PBCH 206 using a single-carrier waveform. The network entity may also transmit the PBCH 206 via different waveforms in different bands or FRs. For example, the network entity transmits the PBCH 206 using a first waveform (e.g., a CP-OFDM waveform) for FR1 and a second waveform with a lower PAPR (e.g., DFT-s-OFDM or single-carrier waveform) for FR2 and sub-THz or THz band(s). For DFT-based PBCH, the network entity may transmit the PBCH 206 using a same or different number of coded bit repetitions per DFT 684. In the diagram 675, a first repetition 692a for a PBCH part 1 and a second repetition 692b for the PBCH part 1 are input to the DFT 684b and mapped to a first PBCH symbol, whereas a first repetition 694a for a PBCH part 2 and a second repetition 694b for the PBCH part 2 are input to the DFT 684c and mapped to a second PBCH symbol. FIGS. 3-6 describe SSB structures for intra-symbol beam tracking. In further examples, other combinations may be used, such as for DFT-based pre-processing of SSS 204, DFT-based pre-processing of PBCH 206, etc. FIGS. 7-8 show methods for implementing one or more aspects of FIGS. 3-6. In particular, FIG. 7 shows an implementation by the UE 102 of the one or more aspects of FIGS. 3-6. FIG. 8 shows an implementation by the network entity 104 of the one or more aspects of FIGS. 3-6.

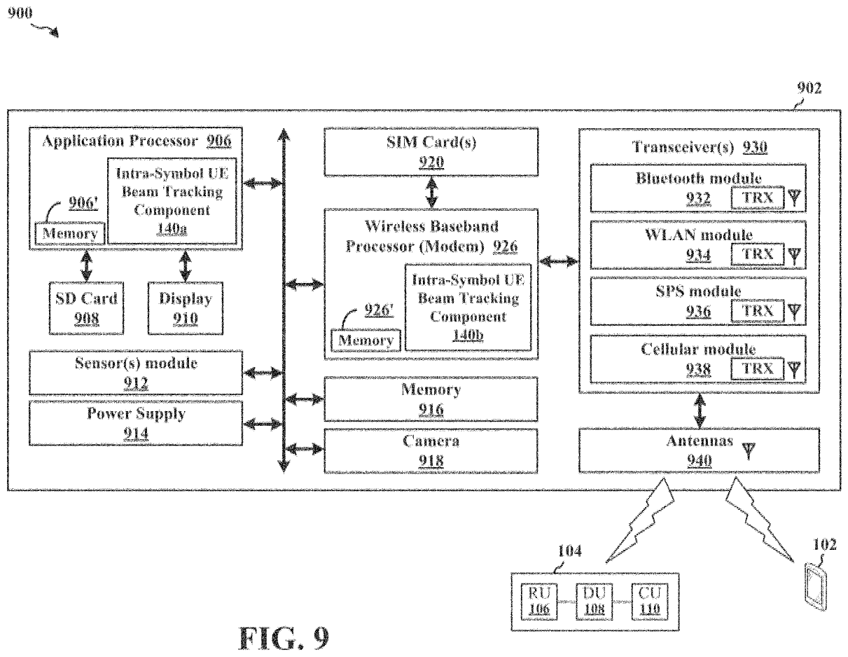

FIG. 7 illustrates a flowchart 700 of a method of wireless communication at a UE. With reference to FIGS. 3 and 9, the method may be performed by the UE 102, the UE apparatus 902, etc., which may include the memory 926′, 906′, 916, and which may correspond to the entire UE 102 or the entire UE apparatus 902, or a component of the UE 102 or the UE apparatus 902, such as the wireless baseband processor 926 and/or the application processor 906.

The UE 102 transmits 705, to a network entity, a UE capability report indicating a capability of a UE for an intra-symbol beam sweeping procedure. For example, referring to FIG. 3, the UE 102 reports 305, to the network entity 104, a UE capability on intra-symbol beam sweeping.

The UE 102 receives 706, from the network entity, a first time-domain portion of an SSB associated with a first beam and a second time-domain portion of the SSB associated with a second beam—the first time-domain portion and the second time-domain portion occur within a same symbol. For example, referring to FIG. 3, the UE 102 receives 306a-306n, from the network entity 104, SSBs used for intra-symbol UE beam sweeping. FIGS. 4-6 further illustrate the first and second time-domain portions of the SSB being transmitted in a same symbol in association with IFDMA resource mappings, as illustrated in FIG. 4, wider subcarriers spacings, as illustrated in FIG. 5, and DFT techniques, as illustrated in FIG. 6.

The UE 102 receives 707, from the network entity, at least one of: an SSS, a DMRS, or a PBCH signal. For example, referring to FIGS. 3-6, the SSBs received 306a-306n from the network entity 104 include SSS 204, DMRS 407, and PBCH 206.

The UE 102 measures 708 the first time-domain portion of the SSB with the first beam and the second time-domain portion of the SSB with the second beam at different times within the same symbol. For example, referring to FIG. 3, the UE 102 measures 308a-308n the SSBs with a plurality of beams at different times within a symbol.

The UE 102 transmits 710, to the network entity, at least one of an access request or a beam report based on the measurement of the first time-domain portion of the SSB and the second time-domain portion of the SSB within the same symbol. For example, referring to FIG. 3, the network entity 104 and the UE 102 perform 310 an initial access and/or a beam report procedure based on the measurement 308a-308n of the SSBs with the plurality of UE beams at different times within the symbol.

The UE 102 communicates 712 with the network entity based on an intra-symbol beam sweeping procedure that includes a measurement of the first time-domain portion of the SSB and the second time-domain portion of the SSB. For example, referring to FIG. 3, the UE 102 performs further communication with the network entity 104 using a network-UE beam pair identified based on the initial access and/or beam report procedure performed 310 according to the measurement 308a-308n of the SSBs with the plurality of UE beams at different times within the symbol. FIG. 7 describes a method from a UE-side of a wireless communication link, whereas FIG. 8 describes a method from a network-side of the wireless communication link.

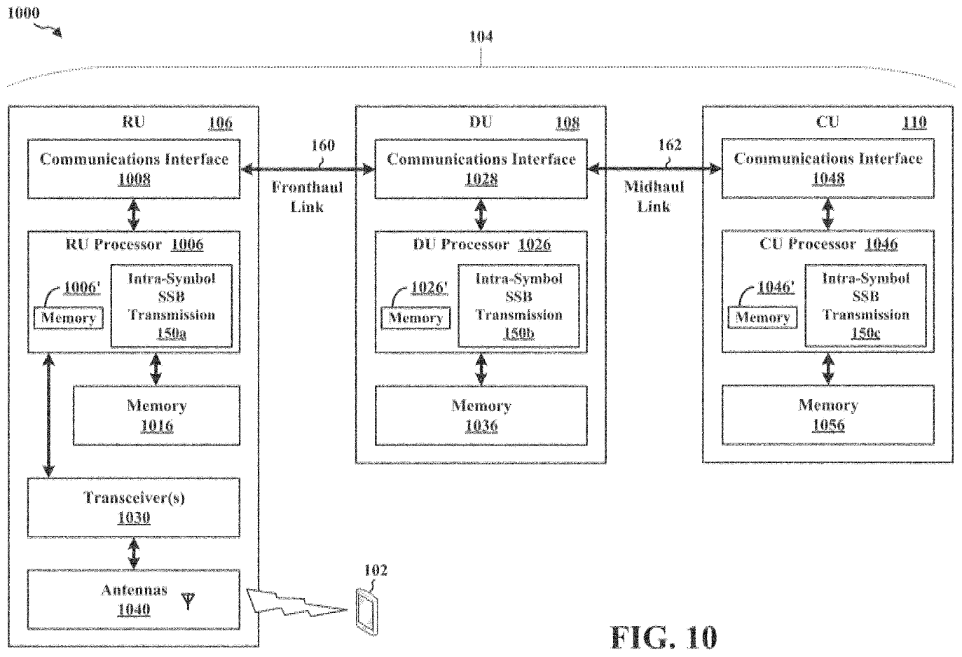

FIG. 8 is a flowchart 800 of a method of wireless communication at a network entity. With reference to FIGS. 3 and 10, the method may be performed by one or more network entities 104, which may correspond to a base station or a unit of the base station, such as the RU 106, the DU 108, the CU 110, an RU processor 1006, a DU processor 1026, a CU processor 1046, etc. The one or more network entities 104 may include memory 1006′/1026′/1046′, which may correspond to an entirety of the one or more network entities 104, or a component of the one or more network entities 104, such as the RU processor 1006, the DU processor 1026, or the CU processor 1046.

The network entity 104 receives 805, from a UE, a UE capability report indicating a capability of the UE for an intra-symbol beam sweeping procedure. For example, referring to FIG. 3, the network entity 104 receives 305, from the UE 102, a UE capability on intra-symbol beam sweeping.

The network entity 104 transmits 806, within a same symbol to the UE, a first time-domain portion of an SSB and a second time-domain portion of the SSB—the first time-domain portion is associated with a first UE beam and the second time-domain portion is associated with a second UE beam. For example, referring to FIG. 3, the network entity 104 transmits 306a-306n, to the UE 102, SSBs used for intra-symbol UE beam sweeping. FIGS. 4-6 further illustrate the first and second time-domain portions of the SSB being transmitted in a same symbol in association with IFDMA resource mappings, as illustrated in FIG. 4, wider subcarriers spacings, as illustrated in FIG. 5, and DFT techniques, as illustrated in FIG. 6.

The network entity 104 receives 810, from the UE, at least one of an access request or a beam report based on the intra-symbol beam sweeping procedure for the first UE beam and the second UE beam. For example, referring to FIG. 3, the UE 102 and the network entity 104 perform 310 an initial access and/or a beam report procedure based on the SSBs transmitted 306a-306n to the UE for the intra-symbol UE beam sweeping. A UE apparatus 902, as described in FIG. 9, may perform the method of flowchart 700. The one or more network entities 104, as described in FIG. 10, may perform the method of flowchart 800.

FIG. 9 is a diagram 900 illustrating an example of a hardware implementation for a UE apparatus 902. The UE apparatus 902 may be the UE 102, a component of the UE 102, or may implement UE functionality. The UE apparatus 902 may include an application processor 906, which may have on-chip memory 906′. In examples, the application processor 906 may be coupled to a secure digital (SD) card 908 and/or a display 910. The application processor 906 may also be coupled to a sensor(s) module 912, a power supply 914, an additional module of memory 916, a camera 918, and/or other related components. For example, the sensor(s) module 912 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 902 may further include a wireless baseband processor 926, which may be referred to as a modem. The wireless baseband processor 926 may have on-chip memory 926′. Along with, and similar to, the application processor 906, the wireless baseband processor 926 may also be coupled to the sensor(s) module 912, the power supply 914, the additional module of memory 916, the camera 918, and/or other related components. The wireless baseband processor 926 may be additionally coupled to one or more subscriber identity module (SIM) card(s) 920 and/or one or more transceivers 930 (e.g., wireless RF transceivers).

Within the one or more transceivers 930, the UE apparatus 902 may include a Bluetooth module 932, a WLAN module 934, an SPS module 936 (e.g., GNSS module), and/or a cellular module 938. The Bluetooth module 932, the WLAN module 934, the SPS module 936, and the cellular module 938 may each include an on-chip transceiver (TRX), or in some cases, just a transmitter (TX) or just a receiver (RX). The Bluetooth module 932, the WLAN module 934, the SPS module 936, and the cellular module 938 may each include dedicated antennas and/or utilize antennas 940 for communication with one or more other nodes. For example, the UE apparatus 902 can communicate through the transceiver(s) 930 via the antennas 940 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 926 and the application processor 906 may each include a computer-readable medium/memory 926′, 906′, respectively. The additional module of memory 916 may also be considered a computer-readable medium/memory. Each computer-readable medium/memory 926′, 906′, 916 may be non-transitory. The wireless baseband processor 926 and the application processor 906 may each be responsible for general processing, including execution of software stored on the computer-readable medium/memory 926′, 906′, 916. The software, when executed by the wireless baseband processor 926/application processor 906, causes the wireless baseband processor 926/application processor 906 to perform the various functions described herein. The computer-readable medium/memory may also be used for storing data that is manipulated by the wireless baseband processor 926/application processor 906 when executing the software. The wireless baseband processor 926/application processor 906 may be a component of the UE 102. The UE apparatus 902 may be a processor chip (e.g., modem and/or application) and include just the wireless baseband processor 926 and/or the application processor 906. In other examples, the UE apparatus 902 may be the entire UE 102 and include the additional modules of the apparatus 902.

As discussed in FIG. 1 and implemented with respect to FIG. 7, the intra-symbol UE beam tracking component 140 is configured to receive, from a network entity, a first time-domain portion of a synchronization signal block (SSB) associated with a first beam and a second time-domain portion of the SSB associated with a second beam, the first time-domain portion and the second time-domain portion occurring within a same symbol; and communicate with the network entity based on an intra-symbol beam sweeping procedure that includes a measurement of the first time-domain portion of the SSB and the second time-domain portion of the SSB. The intra-symbol UE beam tracking component 140 may be within the application processor 906 (e.g., at 140a), the wireless baseband processor 926 (e.g., at 140b), or both the application processor 906 and the wireless baseband processor 926. The intra-symbol UE beam tracking component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 10 is a diagram 1000 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1046, which may have on-chip memory 1046′. In some aspects, the CU 110 may further include an additional module of memory 1056 and/or a communications interface 1048, both of which may be coupled to the CU processor 1046. The CU 110 can communicate with the DU 108 through a midhaul link 162, such as an F1 interface between the communications interface 1048 of the CU 110 and a communications interface 1028 of the DU 108.

The DU 108 may include a DU processor 1026, which may have on-chip memory 1026′. In some aspects, the DU 108 may further include an additional module of memory 1036 and/or the communications interface 1028, both of which may be coupled to the DU processor 1026. The DU 108 can communicate with the RU 106 through a fronthaul link 160 between the communications interface 1028 of the DU 108 and a communications interface 1008 of the RU 106.

The RU 106 may include an RU processor 1006, which may have on-chip memory 1006′. In some aspects, the RU 106 may further include an additional module of memory 1016, the communications interface 1008, and one or more transceivers 1030, all of which may be coupled to the RU processor 1006. The RU 106 may further include antennas 1040, which may be coupled to the one or more transceivers 1030, such that the RU 106 can communicate through the one or more transceivers 1030 via the antennas 1040 with the UE 102.

The on-chip memory 1006′, 1026′, 1046′ and the additional modules of memory 1016, 1036, 1056 may each be considered a computer-readable medium/memory. Each computer-readable medium/memory may be non-transitory. Each of the processors 1006, 1026, 1046 is responsible for general processing, including execution of software stored on the computer-readable medium/memory. The software, when executed by the corresponding processor(s) 1006, 1026, 1046 causes the processor(s) 1006, 1026, 1046 to perform the various functions described herein. The computer-readable medium/memory may also be used for storing data that is manipulated by the processor(s) 1006, 1026, 1046 when executing the software. In examples, the intra-symbol SSB transmission component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 8, the intra-symbol SSB transmission component 150 is configured to transmit, within a same symbol to a UE, a first time-domain portion of an SSB and a second time-domain portion of the SSB, the first time-domain portion associated with a first UE beam and the second time-domain portion associated with a second UE beam; and receive, from the UE, at least one of an access request or a beam report based on an intra-symbol beam sweeping procedure for the first UE beam and the second UE beam. The intra-symbol SSB transmission component 150 may be within one or more processors of the one or more network entities 104, such as the RU processor 1006 (e.g., at 150a), the DU processor 1026 (e.g., at 150b), and/or the CU processor 1046 (e.g., at 150c). The intra-symbol SSB transmission component 150a-150c may be one or more hardware components specifically configured to carry out the stated processes/algorithm, implemented by one or more processors 1006, 1026, 1046 configured to perform the stated processes/algorithm, stored within a computer-readable medium for implementation by the one or more processors 1006, 1026, 1046, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a first time-domain portion of an SSB associated with a first beam and a second time-domain portion of the SSB associated with a second beam, the first time-domain portion and the second time-domain portion occurring within a same symbol; and communicating with the network entity based on an intra-symbol beam sweeping procedure that includes a measurement of the first time-domain portion of the SSB and the second time-domain portion of the SSB.

Example 2 may be combined with Example 1 and includes that the first time-domain portion of the SSB and the second time-domain portion of the SSB correspond to a same spatial-domain transmission filter.

Example 3 may be combined with any of Examples 1-2 and includes that the receiving the first time-domain portion of the SSB and the second time-domain portion of the SSB, further includes: receiving, from the network entity, at least one of: an SSS, a DMRS, or a PBCH signal with an IFDMA resource mapping.

Example 4 may be combined with Example 3 and includes that the IFDMA resource mapping has a repetition factor that is at least one of predefined or indicated through control signaling from the network entity.

Example 5 may be combined with any of Examples 1-4 and includes that the at least one of: the SSS, the DMRS, or the PBCH signal has a wider subcarrier spacing than a PSS of the SSB.

Example 6 may be combined with Example 5 and includes that the wider subcarrier spacing includes a scaling factor that is at least one of predefined or indicated through control signaling from the network entity.

Example 7 may be combined with any of Examples 1-6 and includes that the UE receives the SSB according to a DFT pre-processing procedure.

Example 8 may be combined with Example 7 and includes that the UE receives a number of repetitions of the SSB according to the DFT pre-processing procedure, the number of repetitions being at least one of predefined or indicated through control signaling from the network entity.

Example 9 may be combined with any of Examples 1-8 and further includes transmitting, to the network entity, a UE capability report indicating a capability of the UE for the intra-symbol beam sweeping procedure.

Example 10 may be combined with any of Examples 1-9 and further includes measuring the first time-domain portion of the SSB associated with the first beam and the second time-domain portion of the SSB associated with the second beam at different times within the same symbol.

Example 11 may be combined with any of Examples 1-10 and further includes transmitting, to the network entity, at least one of an access request or a beam report based on the measurement of the first time-domain portion of the SSB and the second time-domain portion of the SSB within the same symbol.

Example 12 is a method of wireless communication at a network entity, including: transmitting, within a same symbol to a UE, a first time-domain portion of an SSB and a second time-domain portion of the SSB, the first time-domain portion associated with a first UE beam and the second time-domain portion associated with a second UE beam; and receiving, from the UE, at least one of an access request or a beam report based on an intra-symbol beam sweeping procedure for the first UE beam and the second UE beam.

Example 13 may be combined with Example 12 and includes that the first time-domain portion of the SSB and the second time-domain portion of the SSB have a same spatial-domain transmission filter.

Example 14 may be combined with any of Examples 12-13 and includes that the SSB includes at least one of: an SSS, a DMRS, or a PBCH signal with at least one of: an IFDMA resource mapping, a wider subcarrier spacing than a PSS of the SSB, or a DFT pre-processing procedure.

Example 15 may be combined with Example 14 and includes that the IFDMA resource mapping has a repetition factor that is at least one of predefined or indicated through control signaling from the network entity.

Example 16 may be combined with Example 14 and includes that the wider subcarrier spacing includes a scaling factor that is at least one of predefined or indicated through control signaling from the network entity.

Example 17 may be combined with Example 14 and includes that the UE receives a number of repetitions of the SSB according to the DFT pre-processing procedure, the number of repetitions being at least one of predefined or indicated through control signaling from the network entity.

Example 18 may be combined with any of Examples 12-17 and further includes receiving, from the UE, a UE capability report indicating a capability of the UE for the intra-symbol beam sweeping procedure.

Example 19 is an apparatus for wireless communication for implementing a method as in any of examples 1-18.

Example 20 is an apparatus for wireless communication including means for implementing a method as in any of examples 1-18.

Example 21 is a non-transitory computer-readable medium storing computer executable code, the code when executed by a processor causes the processor to implement a method as in any of examples 1-18.

1. A method of wireless communication at a user equipment (UE), comprising:
receiving, from a network entity, a first time-domain portion of a synchronization signal block (SSB) associated with a first beam and a second time-domain portion of the SSB associated with a second beam, the first time-domain portion and the second time-domain portion occurring within a same symbol; and
communicating with the network entity based on an intra-symbol beam sweeping procedure that includes a measurement of the first time-domain portion of the SSB and the second time-domain portion of the SSB.

2. The method of claim 1, wherein the first time-domain portion of the SSB and the second time-domain portion of the SSB correspond to a same spatial-domain transmission filter.

3. The method of claim 1, wherein the receiving the first time-domain portion of the SSB and the second time-domain portion of the SSB, further comprises:
receiving, from the network entity, at least one of:
a secondary synchronization signal (SSS),
a demodulation reference signal (DMRS), or
a physical broadcast channel (PBCH) signal,
with an interleaved frequency-domain multiplexing access (IFDMA) resource mapping.

4. The method of claim 3, wherein the IFDMA resource mapping has a repetition factor that is at least one of: predefined or indicated through control signaling from the network entity.

5. The method of claim 3, wherein the at least one of: the SSS, the DMRS, or the PBCH signal has a wider subcarrier spacing than a primary synchronization signal (PSS) of the SSB.

6. The method of claim 5, wherein the wider subcarrier spacing includes a scaling factor that is at least one of: predefined or indicated through control signaling from the network entity.

7. The method of claim 1, wherein the UE receives the SSB according to a discrete Fourier transform (DFT) pre-processing procedure.

8. The method of claim 7, wherein the UE receives a number of repetitions of the SSB according to the DFT pre-processing procedure, the number of repetitions being at least one of: predefined or indicated through control signaling from the network entity.

9. The method of claim 1, further comprising:
transmitting, to the network entity, a UE capability report indicating a capability of the UE for the intra-symbol beam sweeping procedure.

10. The method of claim 1, further comprising:
measuring the first time-domain portion of the SSB associated with the first beam and the second time-domain portion of the SSB associated with the second beam at different times within the same symbol.

11. The method of claim 1, further comprising:
transmitting, to the network entity, at least one of: an access request or a beam report based on the measurement of the first time-domain portion of the SSB and the second time-domain portion of the SSB within the same symbol.

12. A method of wireless communication at a network entity, comprising:
transmitting, within a same symbol to a user equipment (UE), a first time-domain portion of a synchronization signal block (SSB) and a second time-domain portion of the SSB, the first time-domain portion associated with a first UE beam and the second time-domain portion associated with a second UE beam; and
receiving, from the UE, at least one of: an access request or a beam report based on an intra-symbol beam sweeping procedure for the first UE beam and the second UE beam.

13. The method of claim 12, wherein the first time-domain portion of the SSB and the second time-domain portion of the SSB have a same spatial-domain transmission filter.

14. The method of claim 12, wherein the SSB includes at least one of: a secondary synchronization signal (SSS), a demodulation reference signal (DMRS), or a physical broadcast channel (PBCH) signal with at least one of:
an interleaved frequency-domain multiplexing access (IFDMA) resource mapping,
a wider subcarrier spacing than a primary synchronization signal (PSS) of the SSB, or
a discrete Fourier transform (DFT) pre-processing procedure.

15. An apparatus for wireless communication comprising:
a transceiver;
a memory; and
a processor coupled to the memory and the transceiver, the apparatus being configured to:
receive, from a network entity, a first time-domain portion of a synchronization signal block (SSB) associated with a first beam and a second time-domain portion of the SSB associated with a second beam, the first time-domain portion and the second time-domain portion occurring within a same symbol; and
communicate with the network entity based on an intra-symbol beam sweeping procedure that includes a measurement of the first time-domain portion of the SSB and the second time-domain portion of the SSB.

16. The apparatus of claim 15, wherein the first time-domain portion of the SSB and the second time-domain portion of the SSB correspond to a same spatial-domain transmission filter.

17. The apparatus of claim 15, wherein the apparatus configured to receive the first time-domain portion of the SSB and the second time-domain portion of the SSB is further configured to:
receive, from the network entity, at least one of:
a secondary synchronization signal (SSS),
a demodulation reference signal (DMRS), or
a physical broadcast channel (PBCH) signal,
with an interleaved frequency-domain multiplexing access (IFDMA) resource mapping.

18. The apparatus of claim 17, wherein the IFDMA resource mapping has a repetition factor that is at least one of: predefined or indicated through control signaling from the network entity.

19. The apparatus of claim 17, wherein the at least one of: the SSS, the DMRS, or the PBCH signal has a wider subcarrier spacing than a primary synchronization signal (PSS) of the SSB.

20. The apparatus of claim 19, wherein the wider subcarrier spacing includes a scaling factor that is at least one of: predefined or indicated through control signaling from the network entity.
